(19) United States
(12) Patent Application Publication
(10) Pub. No.: US 2018/0063529 A1
(43) Pub. Date: Mar. 1, 2018

(54) AUTOMATED WILDFIRE PREVENTION AND PROTECTION SYSTEM FOR DWELLINGS, BUILDINGS, STRUCTURES AND PROPERTY

(71) Applicant: HAS LLC, Jackson, WY (US)

(72) Inventors: Harry Statter, Jackson, WY (US); Tom Barrett, Noblesville, IN (US); Stephen C. Haeske, Allendale, MI (US); Richard J. Bishop, Blackfoot, ID (US)

(21) Appl. No.: 15/804,040

(22) Filed: Nov. 6, 2017

Related U.S. Application Data
(63) Continuation of application No. 14/805,549, filed on Jul. 22, 2015, now Pat. No. 9,686,552.
Application No. 14/805,549 is a continuation-in-part of application No. 14/080,326, filed on Nov. 14, 2013, now abandoned.
(60) Provisional application No. 61/726,066, filed on Nov. 14, 2012.

(51) Int. Cl. H04N 19/119; H04N 19/577; H04N 19/61; H04N 19/70; H04N 19/112; H04N 19/176; H04N 19/573

(52) U.S. Cl. CPC H04N 19/119; H04N 19/577; H04N 19/61; H04N 19/70; H04N 19/573; H04N 19/112; H04N 19/176

(57) ABSTRACT

A fire retardant delivery system for use with a source of carrier for protection from wildfire is provided. The system includes a retardant tank for storing a fire retardant. The retardant tank is in fluid communication with the source of carrier. A metering valve is constructed and arranged to meter a flow of fire retardant injected into the carrier discharged from the source of carrier to maintain a predetermined proportion of fire retardant to carrier, thereby creating a fire retardant and carrier mixture. At least one distribution nozzle is configured to deliver the fire retardant and carrier mixture to a desired area.

### CROSS-REFERENCE TO RELATED APPLICATIONS

The present patent application claims priority to and is a continuation of U.S. patent application Ser. No. 14/805,539 filed on Jul. 22, 2015 and having the title of “AUTOMATED WILDFIRE PREVENTION AND PROTECTION SYSTEM FOR DWELLINGS, BUILDINGS, STRUCTURES AND PROPERTY,” which is a continuation-in-part of U.S. patent application Ser. No. 14/080,326 filed on Nov. 14, 2013 and having the title “AUTOMATED WILDFIRE PREVENTION AND PROTECTION SYSTEM FOR DWELLINGS, BUILDINGS, STRUCTURES AND PROPERTY,” which claims priority to and is a non-provisional of U.S. Provisional Patent Application Ser. No. 61/726,066 filed on Nov. 14, 2012 and having the title “AUTOMATED WILDFIRE PREVENTION AND PROTECTION SYSTEM FOR DWELLINGS, BUILDINGS, STRUCTURES AND PROPERTY”, all of which are herein incorporated by reference in their entirety.

### TECHNICAL FIELD OF THE DISCLOSURE

The present disclosure generally relates to the apparatus, techniques, and methods designed to protect structures from wildfire and to control wildfire behavior and direction. More specifically, the present disclosure relates to a fire prevention and protection system for mixing, transferring, and distributing a fire retardant in and to desired areas around and on the exterior surfaces of structures when needed, or in specific areas to impede or redirect the progression of the wildfire.

### BACKGROUND OF THE DISCLOSURE

Wildfires across the United States are increasing in frequency and magnitude. Many authorities are calling 2012 the worst year for wildfires in the history of America. In Colorado alone there have been 13 major wildfires, burning 225,000 acres and destroying 600 homes. In 2012, Colorado experienced unusually high temperatures and extremely dry conditions.

Although the relationship between climate change and the incidence of wildfires is speculative, the number of dwellings, buildings, structures, and property at risk is increasing. In the past decade, almost 40% of US homes have been built in the “wildland-urban interface,” or areas where residential neighborhoods border upon forests or grasslands.

This is particularly true in the Central and Western regions of the United States, where wildfires have destroyed thousands of homes and other structures. About $3 billion is spent annually to fight these fires and this figure does not measure the entire economic impact of such fires.

Correspondingly, and as drought conditions continue to spread, the destruction risk from wildfire to residences exists throughout the U.S. and all other forested areas or grasslands in all other parts of the world. Accordingly, this is a global risk without precedent.

As more homes and communities are built along the interface between urban and forested areas, and particularly in areas that are historically burned by wildfires, correspondingly more and more of these structures are directly exposed to the risks of destruction by wildfires. This population and construction trend, coupled with historical timber management practices that have led to increased forest fuel loading in recent decades, and rapidly increasing drought conditions existing across the Central and Western U.S., have led to an unprecedented number of structures being in danger of exposure to, and destruction by, wildfires.

Under certain conditions, conventional methods of fighting wildfires may have little impact when the fires enter the urban-wildland interface where residential subdivisions have been built. Wildfire fighters often can only stand back and watch as homes in the path of a wildfire are destroyed. The inability of wildfire fighters to prevent wildfire from destroying communities has been seen dramatically in the past several years, during which many highly publicized wildfires destroyed thousands of homes throughout the Central and Western U.S., including Arizona, California, Idaho, Nevada, Texas, Oklahoma, Utah and other states.

The costs associated with fighting wildfires pale in comparison to the costs of lost homes and other structures destroyed by wildfires. For example, according to the Insurance Services Office, Inc., the estimated insured losses arising out of the wildfires in San Diego and San Bernadino counties in Southern California in 2003 alone exceeded over $2 billion. Of this, over $1 billion in payments arose out of a single wildfire—the Cedar Fire—which destroyed over 2,200 residential and commercial buildings. On a nationwide basis, the annual insured losses attributable to wildfires for 2012 will be undoubtedly much higher and are known to have exceeded $5 billion by mid-year. The global losses are likely a strong multiple of this mid-year figure and may well exceed $100 billion when finally tallied—which may take some years.

Given the staggering amounts of economic and environmental damage caused by wildfires, there is increasing interest in mitigation techniques that reduce the risks to both communities and forested lands.

With respect to homes and business structures, there are several wildfire mitigation strategies that can be taken to alleviate the risk of wildfires destroying dwellings, residences, and buildings. These include relatively simple measures such as using non-combustible materials during construction and establishing an effective “defensible space” or vegetation clearing around homes located in at-risk areas.

Many communities have adopted on a community-wide basis programs to decrease fuel loads around urban-wildland interfaces by aggressively thinning brush and carefully managing controlled “burns.” Good community planning before residential areas are built is important. It may be unwise to locate residential developments in areas that are highly prone to wildfires and are not conducive to defensible space clearing, brush clearing or controlled burns.

Nonetheless, homes, commercial structures and other buildings continue to be built at the edges of the urban areas where the risk of wildfire is the greatest, and even deep in forested areas, much of the time for aesthetic reasons. Accordingly, there is an immediate need for systems that eliminate, reduce or at least substantially mitigate the risk that wildfires will destroy structures such as homes and the like, wherever they are built. The presently disclosed embodiments are directed toward meeting this need.

### SUMMARY OF THE DISCLOSED EMBODIMENTS

In one aspect, a fire retardant delivery system for use with a source of carrier for protection from wildfire is provided. The system includes a retardant tank for storing a fire retardant. The retardant tank is in fluid communication with the source of carrier. A metering valve is constructed and arranged to meter a flow of fire retardant injected into the carrier discharged from the source of carrier to maintain a predetermined proportion of fire retardant to carrier, thereby creating a fire retardant and carrier mixture. At least one distribution nozzle is configured to deliver the fire retardant and carrier mixture to a desired area.

In another aspect, a method of operating a fire retardant delivery system is provided. The method includes storing a fire retardant in a retardant tank, and positioning the retardant tank in fluid communication with a source of carrier. The method also includes discharging the carrier from the source of carrier, and metering a flow of fire retardant injected into the carrier to maintain a predetermined proportion of fire retardant to carrier, thereby creating a fire retardant and carrier mixture. The method also includes delivering the fire retardant and carrier mixture to a desired area.

### BRIEF DESCRIPTION OF THE DRAWINGS

The embodiments described herein will be better understood and its numerous objects and advantages will be apparent by reference to the following detailed description of the embodiments when taken in conjunction with the following drawings.

FIG. 1 is a schematic top plan view of a residential structure and the area surrounding the structure, illustrating one embodiment of the fire retardant distribution system according to the present embodiments.

FIG. 2 is a schematic layout view of the fire retardant distribution system shown in FIG. 1 with the structure removed to illustrate the system.

FIG. 3 is a schematic view of the primary systems according to one embodiment, including the distribution system, the storage system and the control system.

FIG. 4 is a schematic view of the control system according to one embodiment.

FIG. 5 is a schematic top plan view of a perimeter fire retardant distribution system according to a second embodiment.

FIG. 6 is a schematic view of another primary system according to one embodiment, including the distribution system, the storage system and the control system.

FIG. 7A is a schematic view of another primary system according to one embodiment, including the distribution system, the storage system and the control system.

FIG. 7B is a schematic view of another primary system according to one embodiment, including the distribution system, the storage system and the control system.

FIG. 7C is a schematic view of another primary system according to one embodiment, including the distribution system, the storage system and the control system.

FIG. 7D is a schematic view of another primary system according to one embodiment, including the distribution system, the storage system and the control system.

FIG. 8A is a schematic view of a containment module according to one embodiment.

FIG. 8B is a schematic view of a containment module according to one embodiment.

FIG. 9 is a schematic view of a control system according to one embodiment.

### DETAILED DESCRIPTION OF THE DISCLOSED EMBODIMENTS

In some embodiments, a fire retardant distribution system is disclosed for use on any type of structure including residences, out buildings, barns, commercial buildings, and others, to name just a few non-limiting examples. The system is designed to prevent structures from catching fire when a wildfire approaches, and relies upon a spray system that when activated quenches and coats the exterior of the structures, decks and surrounding landscape very rapidly with a fire retardant that remains on the surface until washed off. The system is self-contained and relies upon tanks pressurized by a motive source such as inert gas, combustible fuel, electric, gravity, pump, or another power source to deliver the fire retardant to spray valves positioned on and around the structures. The motive source is operatively coupled to the retardant tank and the source of carrier.

There may be no need for electrical power in some embodiments, although electrical power may be supplied by a battery backup system, uninterruptible power supply, or other source of local electrical energy if an electrically operated control system is used. The system may be activated manually, or may optionally include a control module that allows the system to be activated in any number of ways, including inputs by manual activation, remote telemetry and by remote access (such as by DTMF telephone, mobile device application, or internet link, to name just a few non-limiting examples).

Other embodiments are directed toward blocking or re-directing the progress of a wildfire, and comprise a pump powered by combustible compressed fuel, electric, or other power source that is connected to a reservoir of non-pressurized retardant and a series of distribution devices connected to the outflow of the pump. The distribution devices are positioned to spray the fire retardant in a line or arc that either blocks progress of a wildfire, or channels or blocks the direction of the fire in a desired manner. Several subsystems, each comprising a pump and the associated distribution devices may be laid out in series so that a fire retardant protection line several miles long may be quickly laid down on vegetation. This “flanking” technique allows wildfire fighters to control fire direction and behavior at critical points, typically near communities.

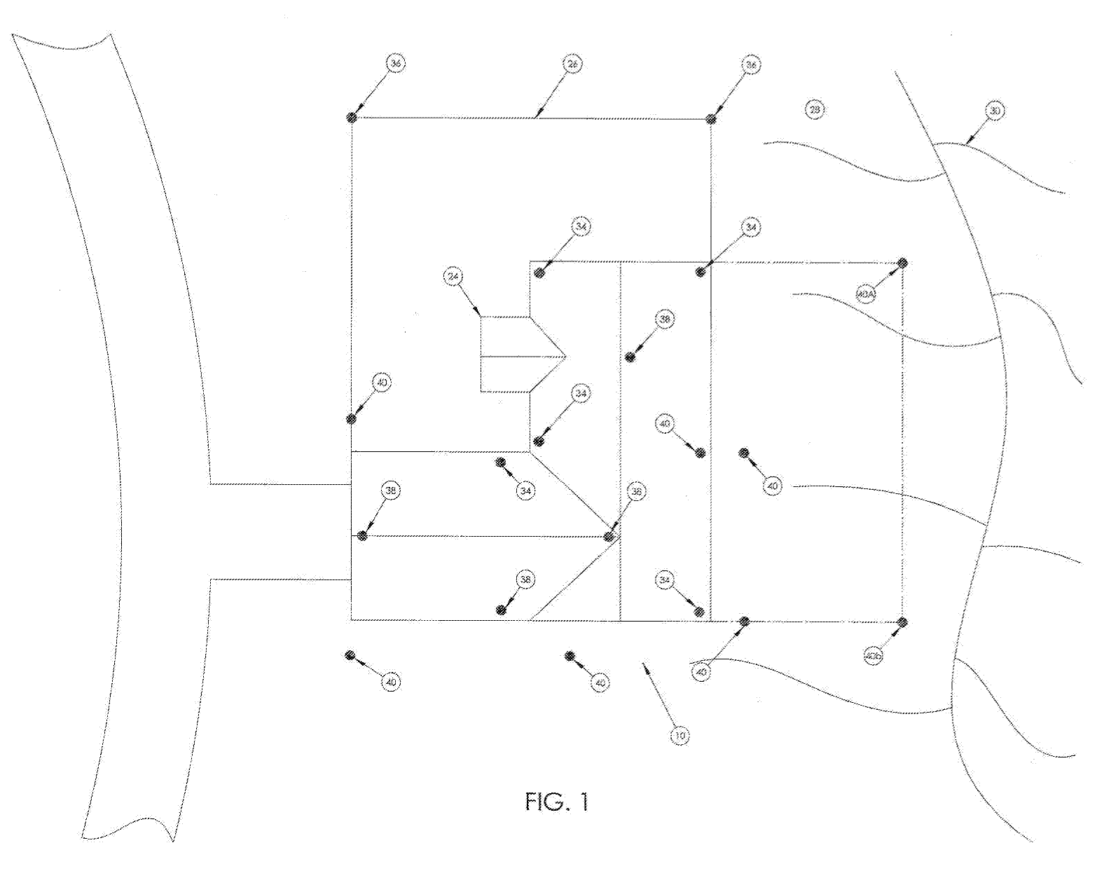

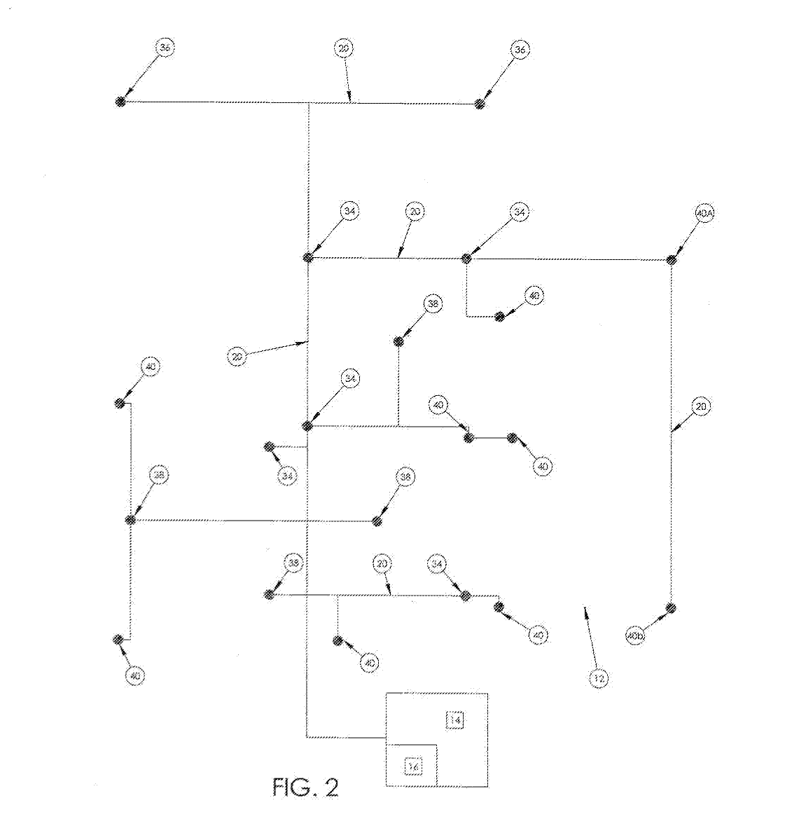

With reference to FIGS. 1 and 2, a fire retardant distribution system 10 is illustrated schematically in a typical installment in a residential setting that includes a building 24 such as a typical home located near an urban-wildfire interface area. The system illustrated in FIGS. 1 and 2 is only an illustrative example, and those skilled in the art will recognize from the present disclosure that many other configurations are possible and will be configured depending upon the desired area to be protected. In one embodiment, the desired area is defined as an area between a structure and at least one historical fire originating location. In one embodiment, the desired area is defined based upon temperature inputs from real-time remote telemetry. In one embodiment, the desired area is defined based upon relative humidity inputs from real-time remote telemetry. In one embodiment, the desired area is defined based upon wind patterns inputs from real-time remote telemetry. In one embodiment, the desired area is defined based upon historical fire data. In one embodiment, the desired area is defined based upon fuel distribution patterns.

The system 10 includes several different components or subsystems, including a fluid-based distribution system shown generally at 12 and comprising the pipes and nozzle systems through which the fire retardant is delivered to and applied on surfaces, a carrier (such as water or other fire retardant carrier) and fire retardant storage system shown generally at 14 and comprising the storage tanks for storing separately both the carrier and the fire retardant when the system is not in use, and pressurization tanks for pressurizing the system and associated hardware, and a control system shown generally at 16 and comprising generally the devices necessary for activating the distribution system 10. Each of these components is described in detail below.

The system 10 shown in the figures illustrates a typical residential installation in which the system is configured to deliver the water based fire retardant to the exterior surfaces of the building 24, a deck 26 attached to the building, and surrounding areas such as landscaping 28. In FIG. 1, the building is shown located adjacent to a canyon area 30 to illustrate both structure protection and possible “flanking” distribution.

The distribution system 12 is shown in isolation in FIG. 2 and comprises a system of pipes 20 and distribution spray nozzles connected to the pipes at engineered positions. The distribution system 12 illustrated herein also includes pipes 20 extending to the edge of the canyon area 30. The type and size of piping 20 used in a distribution system 12 depends on factors such as the size of the system and the amount of water and retardant that will be delivered through the system. Generally, any type of UV resistant tubing will work well for the pipes 20 used in system 12, including for example polyvinylchloride (PVC) pipe, polyethylene tubing, copper tubing, galvanized pipe, or steel pipe, to name just a few non-limiting examples. With some combinations of metallic pipe and fire retardant, care must be taken to avoid corrosion of the pipes caused by the particular retardant that is used. The diameter of the pipe 20 also depends on the volume and the operating pressure of fire retardant delivered through the system.

The pipes 20 and associated distribution spray nozzles define a distribution system 12 for the fire retardant contained in the storage system 14. The piping is connected to the various source tanks for the fire retardant as described below and is plumbed through the walls of the structure or is buried underground. In some embodiments, the piping 20 is installed during initial construction of the building 24 so that it may be installed in an “in-wall” manner for aesthetic purposes, under sheet rock and the like. However, the system 10 may often be retrofitted into existing buildings, in which cases the piping 20 may be run under eves and the like in a manner designed to be as inconspicuous as possible, while maintaining convenient access for maintenance purposes.

The distribution system 12 may include several different types of distribution spray nozzles. Each nozzle has a specified purpose. For example, exterior wall nozzles 34 are located at strategic positions along the perimeter of the building 24 so that the exterior surfaces of the building 24 are coated with fire retardant when the system is activated. Thus wall nozzles 34 are mounted under the eves or overhangs of building 24 and are configured to direct a sprayed stream of fire retardant onto the exterior walls of the building. There are six wall nozzles 34 shown in FIGS. 1 and 2, but as many wall nozzles are plumbed into the system as are necessary to uniformly coat the entire exterior wall surface area (or as much thereof as is practical). In some embodiments, wall nozzles 34 may be mounted approximately every 30 lineal feet along the length of the wall, but the separation may be more or less depending upon system design specifics.

Likewise, the system 10 shown in FIGS. 1 and 2 includes two deck nozzles 36 located around deck 26. These deck nozzles direct a spray of fire retardant onto the horizontal surface of the deck and if desired, may be the type of nozzles that rotate through a complete circle so that they also deliver fire retardant to adjacent landscape areas.

In FIGS. 1 and 2 there are four roof nozzles 38 situated so that they spray the entire roof surface. And the system 10 shown in FIG. 2 includes nine separate landscape nozzles 40 positioned around the landscaping 28, two of which (labeled 40a, 40b) are positioned adjacent to the canyon area 30. It will be appreciated that in some embodiments the pipe 20 is buried underground in the landscaped areas for many reasons, including aesthetic, climate protection and damage control.

Each of the nozzles used with system 10 is of a type appropriate for the specific location. In some embodiments, wall nozzles 34 typically are misting or flat sheet spray nozzles having about ½ inch diameter. These nozzles are mounted in some embodiments under the eaves of the building such that the nozzles protrude about 1 and ½ inches from the eave. These nozzles may be plastic, stainless steel, or brass, to name just a few non-limiting examples. In some embodiments, these nozzles do not rotate but instead direct a spray, stream, arc or mist directly onto the vertical walls of the building. Nonetheless, in other embodiments these nozzles may be configured to rotate when they are pressurized to thereby spray fire retardant onto adjacent surfaces such as soffits, decks and the surrounding exterior ground.

In some embodiments, the deck nozzles 36 may be of the type typically seen in in-ground irrigation systems, such as pressure pop-up rotating sprinkler nozzles. These nozzles may be set to rotate through a complete 360° circle, or only part of a circle. In other embodiments, impact driven sprinkler nozzles may also be used for the deck nozzles.

Roof nozzles 38 may be of the spray or impact type. In many embodiments, all nozzles in system 10 are mounted so that they are either concealed or minimally visible when not in use so as not to detract from the aesthetic appearance of building 24. Thus, retractable type distribution nozzles may be mounted in the ground or in special boxes mounted on the deck, for example. Similarly, the roof nozzles 38 may be mounted in architectural features on the peak of the roof such as cupolas or dormers. The cupola may be built to include blowout louvers and similar fittings that are instantly blown out when the fire retardant begins spraying out of a nozzle. A cupola also may be built to accommodate a retractable sprinkler head for use in the roof nozzle 38. Regardless of the type of nozzle used, there are sufficient roof nozzles 38 located along the peaks and ridges of the building's roof so that the entire roof is sufficiently and uniformly coated with fire retardant as to prevent and protect substantially the potential wildfire damage.

Similarly, the landscape nozzles 40 are selected to be of a type that is appropriate to the particular location. Pressure operating, retractable distribution nozzles are used in some embodiments, but other distribution heads also work well. With respect to the two landscape nozzles 40a and 40b located adjacent to the edge of the canyon area 30, these are in some embodiments impact heads, or “gun” type agricultural heads more commonly used to irrigate row crops.

In many embodiments, the distribution system 12 is not charged with fire retardant when the system is not in use. In other words, the pipe 20 is empty when the system is not in use. This eliminates any problems with freezing or corrosion from the fire retardant resident in the pipes (in combinations where this is a concern).

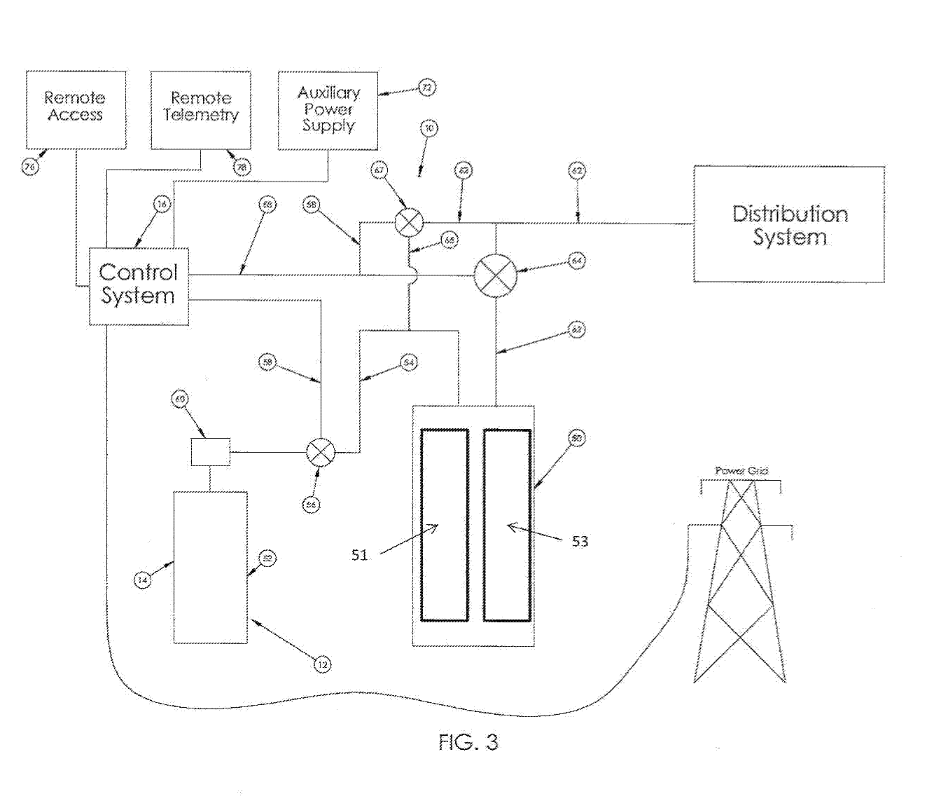

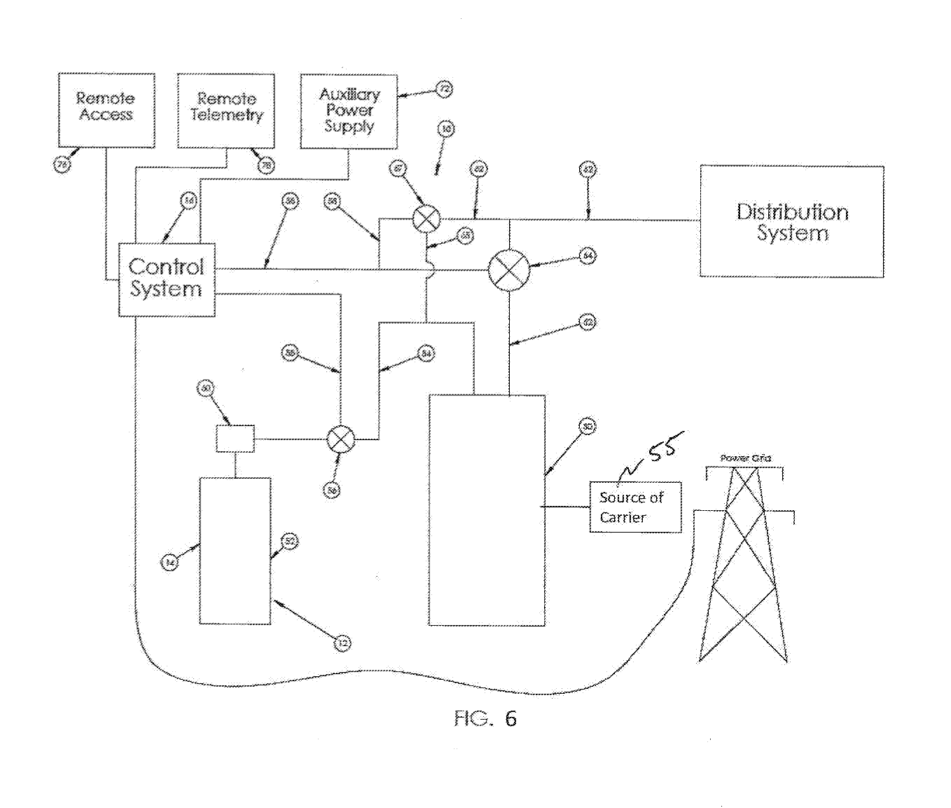

The storage system 14 will now be described in detail with particular reference to FIG. 3. In FIG. 3, the distribution system 12, storage system 14 and control system 16 are shown schematically. Storage system 14 comprises one or more water or other carrier based fire retardant tanks, pressurization systems, and control valves for operating the system. Specifically, the storage system 14 illustrated in FIG. 3 typically utilizes a double tank arrangement 50 and a single pressurization tank 52. In some instances the double tank arrangement will be modified to include either a single tank or some multiple of the double tank arrangement. Alternatively, in some instances, as shown in FIG. 6, the system relies on a carrier from a source other than a tank such as a water well, municipal water supply, pond, water well, water tank, lake, or any other such water supply source that is used to provide a carrier that is fluidly coupled with a fire retardant from a tank. Hereinafter said tank arrangements will be referred to as “double tank arrangement 50”. The double tank arrangement 50 contains both water or other carrier and the fire retardant, separated for storage purposes into a carrier tank 51 and a retardant tank 53. During storage, the carrier and the fire retardant are stored in a non-pressurized state. The size and volume of said tanks 50 varies according to the size of system 10. The double tanks 50 are sized so that the tanks have adequate volume to spray the desired volume of the fire retardant mixture uniformly over the entire area intended to be covered by the system 10. A variety of tank types may be used for the double tank arrangement 50. For example, double tank arrangement 50 may be fiberglass reinforced plastic, HDPE or steel, lined appropriately with corrosion resistant materials, to thereby prevent corrosion in the tanks which may impair system function when needed for fire suppression purposes. In a typical residential installation, the double tank arrangement 50 has a combined capacity of about 100 to about 350 gallons or larger. Larger tanks of up to 10,000 gallons or more may be used with large structures or where retardant is to be sprayed over a large area or in community-based systems.

Some kinds of fire retardants that may be used in system 10 tend to stratify or chemically separate over time, rendering them inactive or ineffective. Depending upon the type of fire retardant used, the double tank arrangement 50 may be fitted with agitators such as bubbler or paddle-type mixers to keep the fire retardant homogenous and active or useful over time. A secondary bubbling line (not shown) may be run from the pressure tank 52 into the fire retardant tank 50 to cause either continuous or intermittent bubbling of nitrogen or other gas, which is sufficiently chemically inert to be useful and practical, through the fire retardant to mix the fire retardant and thus prevent stratification. The control system 16 may be configured to provide bubbling into the fire retardant tank itself when the system 10 is either activated or when stratification is suspected or to prevent stratification by time cycle operation.

The double tank arrangement 50 is plumbed to pressure tank 52 through a pressure line 54. A valve 56 is in pressure line 54 and is, as detailed below, connected to and operable under the control of control system 16 through control line 58. A pressure regulator 60 with a vent is provided to regulate the pressure in pressure tank 52. A system flush pipe 65 branches from pressure line 54 and connects to outlet pipe 62 upstream from valve 64. A valve 67 is plumbed into flush pipe 65. The system flush pipe 65 is explained below.

In some embodiments, pressure tank 52 may be a commercially available cylinder or set of cylinders charged with an inert pressurized gas such as nitrogen that serves as the motive force for the system 10 to deliver the water based fire retardant through pipes 20 to the various nozzles. Pressure tank 52 is of a sufficient volume and is charged to an appropriate pressure such that when the system 10 is activated, all or a portion of the fire retardant mixture contained in the double tank arrangement 50 may be delivered through the nozzles at an operating pressure appropriate to the system—about 50-60 psi in some embodiments. A pressure regulator is typically used to regulate the operating pressure of gas delivered from pressure tank 52 to the double tank arrangement 50 and the nozzles downstream of the tank 50. In some embodiments, the double tank arrangement 50 is capable of being pressurized up to about 120 psi or less.

Upon actuation of the system 10 the fire retardant and the carrier are mixed into a fire retardant and carrier mixture. Fire retardant contained in the double tank arrangement 50 is delivered to the piping 20 on FIG. 2 of distribution system 12 through an outlet pipe 62. As noted, a valve 64, which is under the control of the control system 16 through control line 58, is plumbed into outlet pipe 62 near the double tank arrangement 50.

In one embodiment, as shown in FIG. 6, the double tank arrangement 50 in FIG. 3 may be limited to a single or multiple tank arrangement of fire retardant in which case the carrier is not contained within a tank. In such a non-limiting example, the carrier is provided through another source 55 such as a water well, municipal water supply, pond, water well, water tank, lake or any other carrier source available piped to the fire retardant tank or tanks through a piping system. In such a non-limiting example, the other carrier source is fluidly coupled to the single or multiple tanks of fire retardant and delivered to the piping on FIG. 2 of distribution system 12 through an outlet pipe 62.

In installations of system 10, the storage system 14 on FIG. 2 may be located in any appropriate setting such as in a garage, HVAC area, out building or constructed pad.

It will be appreciated that storage system 14 may utilize multiple double tank arrangements 50 and multiple pressure tanks 52 if the size of the system 10 is sufficient to warrant the capacity achieved by additional tanks.

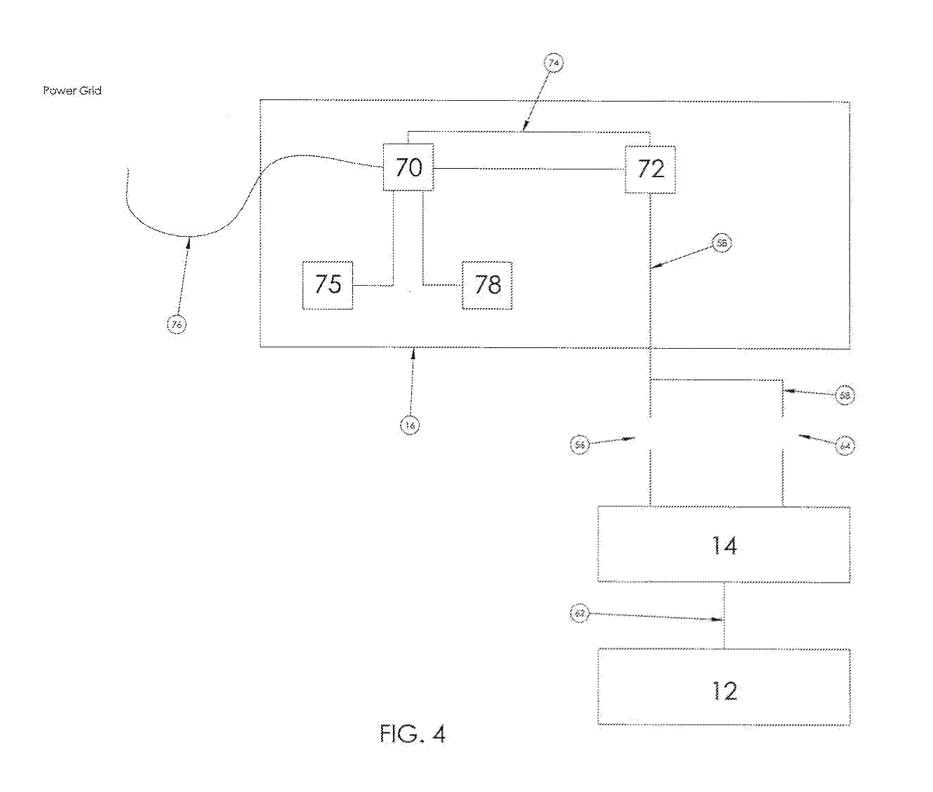

Control system 16 (or activation system 16) is shown schematically in detail in FIG. 4 and includes an activation switch 70, which is typically an electronic switch such as a solenoid or mechanical relay or the like, and an auxiliary power supply 72 such as an external battery and/or uninterruptible power supply module. The control system 16 is operably coupled to the motive source and operable to actuate the motive source. Activation switch 70 is the main on/off switch for activating system 10 and is normally powered by the power supply to the building or location. However, in wildfire situations electric power from public utilities and the like may be cut off. Auxiliary power supply 72 provides electric power to activation switch 70 through wiring 74 to ensure that activation switch 70 is powered under all circumstances, even where the external electrical power supply has been interrupted. As indicated earlier, control lines 58 interconnect control system 16 to valves 56 and 64, which preferably are electrically operated solenoid valves. Alternately, all of the valves described herein may be operated pneumatically, hydraulically or manually (to name just a few non-limiting examples), depending on the type of system that is being used.

Activation switch 70 is operable under a variety of input systems that are capable of activating system 10. For example, switch 70 may be activated with a manual switch 75 that is located in, on or adjacent to the building 24. If a wildfire is approaching the building, the manual switch 75 is activated to begin activation of the system 10.

Activation switch 70 is further operable via coded remote activation 76 such as an internet portal access, mobile device application or as a coded series of tones (such as DTMF tones generated by a telephone handset) as may be desired. Thus, control system 16 may include a telephony systems wire to the landline, cellular or satellite phone systems so that switch 70 may be remotely operated by calling a specific telephone number and entering codes manually or automatically. The building owner, the local fire departments, etc. may use the coded remote access 76 by dialing the number, activating the applications or suitably transmitting a code or signal. Switch 70 may also be operated by on-site detectors 78 such as infrared, smoke, temperature, and/or other fire detectors located around the building, or by similarly situated RF or IR or laser controlled devices. For example, an infrared detector may be located near the edge of canyon area 30. If a wildfire is detected, the detector is capable of activating switch 70. Similarly, heat sensors and other types of similar sensors may be located around or near a building, or near the edge of canyon area 30 and configured for activating system 10.

The fire retardant used in system 10 is in some embodiments a liquid, gel or powder that when properly combined or mixed with water or other carrier flows readily through the plumbing systems and through the nozzles. Because the retardant component may not be used for several years after double tank arrangement 50 is filled, in some embodiments the retardant is not prone to degradation in effectiveness over time. Because the fire retardant is sprayed over buildings, in some embodiments the retardant does not discolor building surfaces, does not harm vegetation, and causes no other environmental damage. A wide variety of fire retardants suitable for use in system 10 are commercially available and may be selected on a project-by-project basis. By way of non-limiting example, fire retardants marketed commercially under the brand names Barricade, Phos-Chek, TetraKO, and FireIce may be used.

Operation of system 10 will now be detailed. When system 10 is not in use, or “idle”, the fire retardant double tank arrangement 50 is substantially filled with water or other suitable carrier and the fire retardant respectively but is not pressurized; alternatively, a single tank or multiple tanks may be filled with fire retardant and a suitable carrier is provided through any other suitable source of carrier (not within the tank(s)). Valves 56, 64 and 67 are closed. System 10 is activated in any number of the ways detailed above. For purposes of illustration, in this case it is assumed that the system 10 is installed in a residential structure and authorities, because of the threat posed by an approaching wildfire, have evacuated the resident of the structure. In other words, the system 10 was not activated prior to the building being evacuated. When the owner deems that the structure is imminently threatened by wildfire, the owner accesses the system by the Internet, smart phone application or calls the number for the coded remote activation 76 of control system 16 on either a WiFi portal, landline, cellular or satellite phone. The coded remote activation 76 is configured to respond to the incoming access signal and will prompt the caller to activate switch 70—that is, to turn switch 70 from the “off” to the “on” position. For example, the coded remote activation 76 may prompt the caller to enter an authorization code such as a user name and password or numeric code to first insure that the caller is authorized to give the system further instructions. If the correct user name and password or numeric code is entered, the coded remote activation 76 will next prompt the caller to a specific activation code or selection from a menu that may include status checks, inputs from sensors or to activate the activate switch 70.

When the caller enters the activation code, control system 16 sends appropriate signals to valves 56 and 64, which as noted are electrically operated valves such as solenoid valves, causing the valves to open. As valve 56 opens, gas from the pressure tank 52 flows into and pressurizes the double tank arrangement 50. With valve 64 open, both the water and fire retardant begins flowing into outlet pipe 62 under the pressurizing force applied by gas from pressure tank 52, and thus into the entire distribution system 12. Proportional measures of both carrier and the fire retardant are maintained by pre-set pressures or other such mixing systems such as injector, venturi eduction, injection pitot etc. The mixing system may contain multiple points of injection, venturi eduction, injection pitot, etc. The now blended or mixed fire retardant flows quickly into pipes 20 and begins to be discharged from each of the nozzles in the system. Although the nozzles in the system are configured to apply the desired amount of fire retardant onto adjacent surfaces, a typical application rate is between the range of 0.5 and 5 gallons per 100 square feet of surface. The desired amount may be calculated by the control system at the time of activation with inputs from remote sensors or the owner/operator. Additionally, this application rate may vary with the type of fire retardant used.

The fire retardant is sprayed out of the nozzles onto the intended surfaces until either the entire volume contained in the double tank arrangement 50 is sprayed through the nozzles, or the system is deactivated by deactivating switch 70—that is, the switch 70 is moved from the “on” to the “off” position which is dependent on the type of switch selected by the design process. In this regard, in some embodiments pressure tank 52 contains enough pressurized gas to discharge the entire contents of fire retardant contained in the double tank arrangement 50 when said double tank arrangement 50 is full, and to clear all fire retardant contained in all plumbing lines in distribution system 12. Thus, if the system 10 remains activated until all fire retardant is discharged through the nozzles, gas from pressure tank 52 will flush all plumbing lines of fire retardant.

Similarly, the activation switch 70 may be turned off in any of the ways described above at any time after activation. When the control system 16 deactivates the system 10 (i.e. turns switch 70 off), both valves 56 and 64 are closed. The activation switch may be turned off and then turned on again at a later time provided there is sufficient water and fire retardant in the double tank arrangement 50.

Control system 16 is capable of closing valves 56 and 64 at different times. For example, valve 56 may be closed before valve 64 so that the double tank arrangement 50 is allowed to depressurize for an interval of time. Valve 64 is then closed by control system 16. If deactivation is accomplished through use of various types of coded remote activation 76 (as previously described) before all water or fire retardant contained in double tank arrangement 50 has been discharged through system 10, the fire retardant mixture remaining the in the pipes 20 downstream of double tank arrangement 50 may be flushed out to clear the piping in the system to ready it for the next use. This is done by opening valves 56 and 67 with valve 64 closed. Valves 56 and 67 are allowed to remain open until all residual fire retardant has been discharged through the various nozzles.

In some embodiments, the fire retardant used in the system 10 is of the type that will remain on the surface onto which it has been sprayed, providing continuing protection against wildfire, until the residual retardant has been washed off.

It will be appreciated by those of ordinary skill in the art that certain modifications and additions may be made to the system 10 as described above and shown in the drawings. For example, the system may be designed to operate on a manual basis only, thereby omitting control system 16. In this case, only one manually operable valve may be used in place of valve 56 shown in the drawings and the system is activated by manually opening the valve to deliver gas from the pressure tank to the double tank arrangement 50. Also a hose having a nozzle on one end may be connected to the double tank arrangement 50 to allow mixed fire retardant to be manually sprayed on specific locations. Separate lines may be plumbed into the system similar to standard hose bibs that allow firefighters to connect external hoses to the actual fire retardant supply. As yet another modification, large “guns” of sprinkler heads such as impact heads may be mounted at tree-top level to provide greater coverage of the surrounding structures. Moreover, entire communities may be protected by a single, large-scale installation along the lines noted above. In this case, each structure in a community may be individually protected by a system 10, with a community perimeter system for delivering fire retardant to a line around the community may be used to great effect.

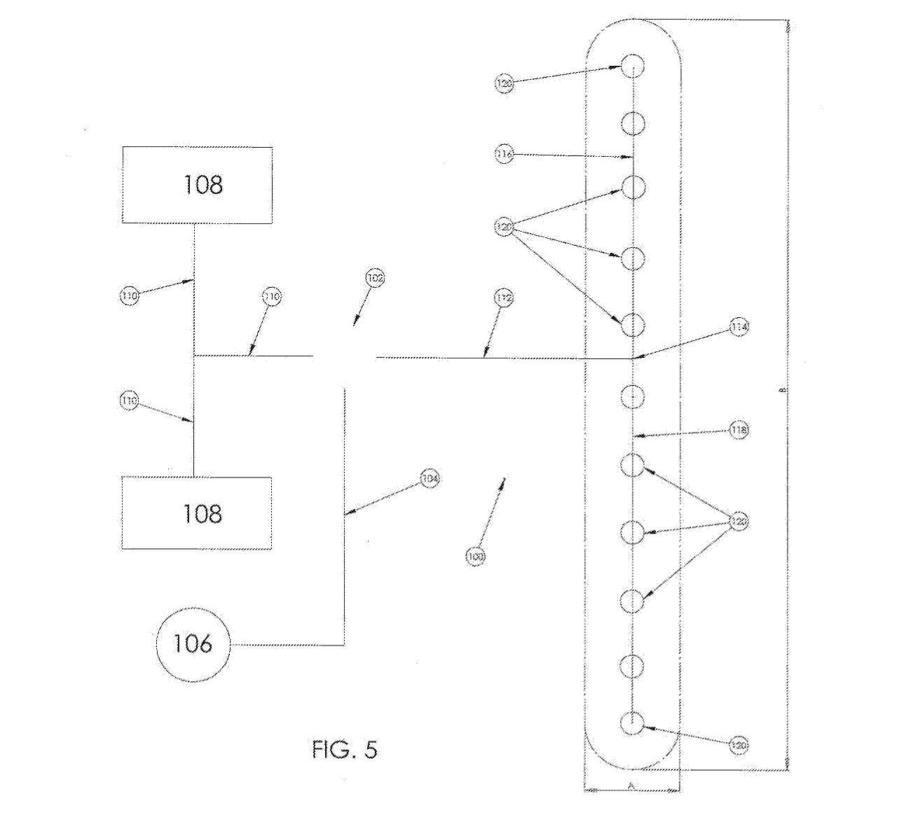

An additional embodiment is shown in FIG. 5. In this system 100, which is the type of system that is used to flank a fire to control fire direction or stop the fire's progress in a specific direction, a series of “big gun” distribution heads (such as those available from Nelson Irrigation Corporation, 848 Airport Road, Walla Walla, Wash. 99362-2271 USA) are positioned to spray fire retardant in a line over a relatively long distance. In many areas, historical fire data is available that provides a reliable statistical indicator of the direction that wildfires travel. In other words, in any given area, by relying upon factors such as weather, wind patterns, fuel distribution and historical fire data, firefighters are able to reliably predict wildfire direction and behavior. The system 100 is used to flank a fire by laying down a long line of fire retardant that is intended to stop a fire, or channel it away from a residential area, or toward an area where it is easier to fight, etc.

In some embodiments, system 100 relies upon a compressed gas powered pump 102 that is powered by compressed gas delivered to pump 102 through a line 104 that interconnects the pump to a tank 106 of a suitable compressed gas. Pump 102 may be a diaphragm-type pump such as the IR ARO™ diaphragm-type pumps available from Ingersoll-Rand Fluid Products (170/175 Lakeview Drive, Airside Business Park, Swords, Co. Dublin, Ireland), to name just one non-limiting example, and may be powered with compressed nitrogen or air in tank 106.

One or more reservoirs 108 consisting of multiple double tank arrangements 50 of both carrier or fire retardant are plumbed to pump 102 through pipes 110. These reservoirs 108 may be portable or located above ground, underground, or remotely from pump 102, as may the tank 106, depending upon the specific installation. A single outflow pipe 112 from pump 102 may be connected to a T-fitting 114 and there are two branch lines 116, 118 extending from the T-fitting. Plural spray distribution heads 120 are plumbed inline in the branch lines 116 and 118 —twelve distribution heads 120 are shown in the system 100 in FIG. 5.

Each distribution head 120 is preferably a “big gun” type of spray head configured to distribute a desired quantity of fire retardant. In the embodiment illustrated in FIG. 5, the system 100 is pressurized and the components are sized so that fire retardant is sprayed from each distribution head in a circle having a diameter of about 100 feet (dimension A in FIG. 5). It will be appreciated that the length of the perimeter line defined by branch lines 116 and 118 may be up to ¼ mile, and more, as shown by dimension B, FIG. 5. The area of ground onto which fire retardant is distributed with the system 100 is illustrated with dashed lines around the perimeter of the system.

Depending upon the area that is to be protected, several systems 100 may be arranged in series to provide a protection line that is many miles in length. The system 100 may beneficially be used to deliver fire retardant to at least a part of a perimeter around a residential area, and in particular those perimeter areas that are most prone to be hit by wildfire.

System 100 includes activation means for activating the system, which may be of any of the types described above.

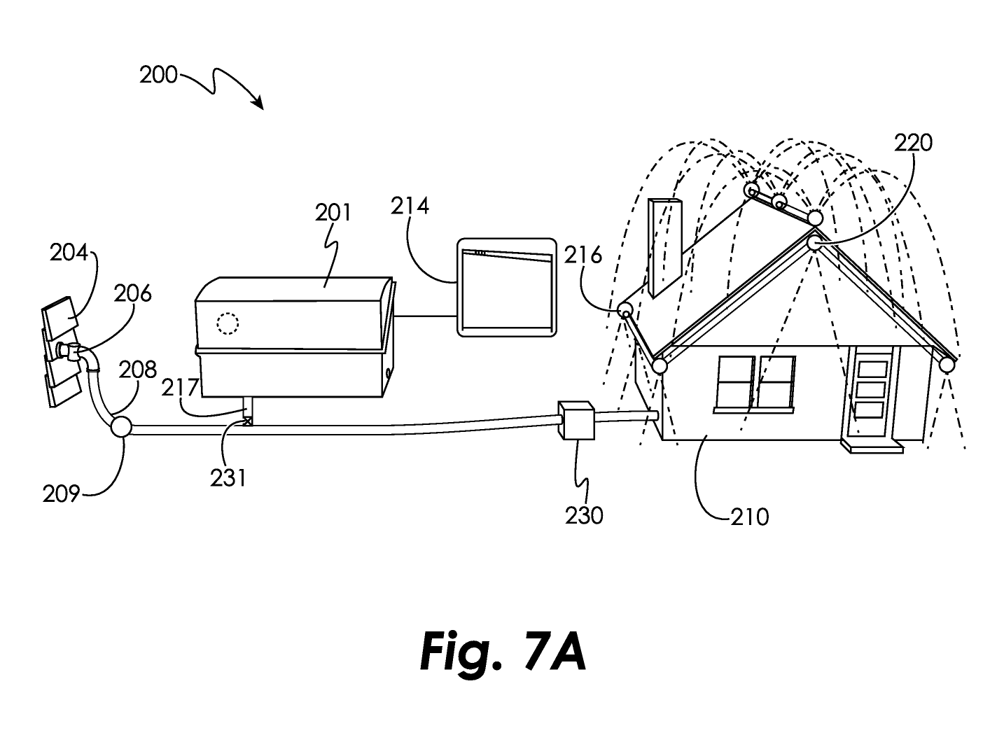

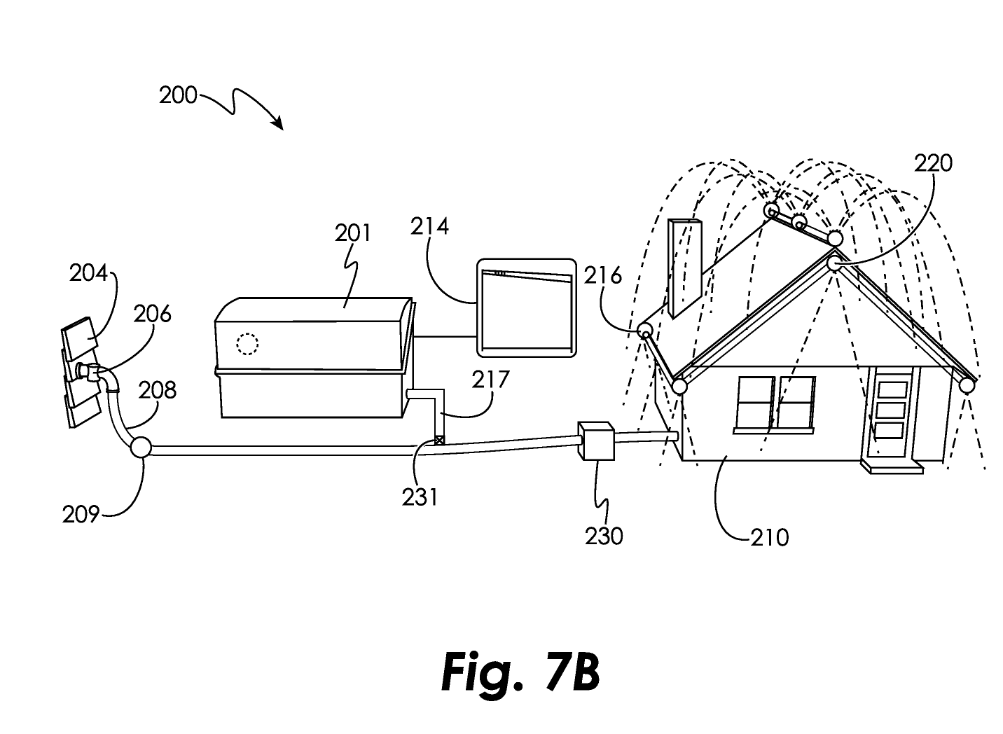

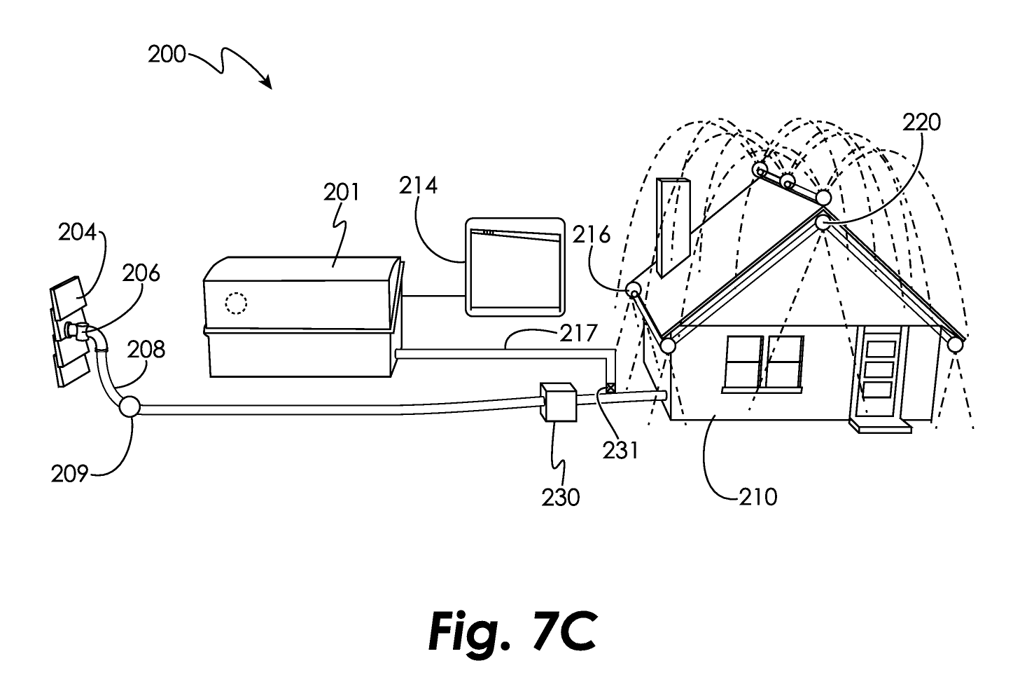

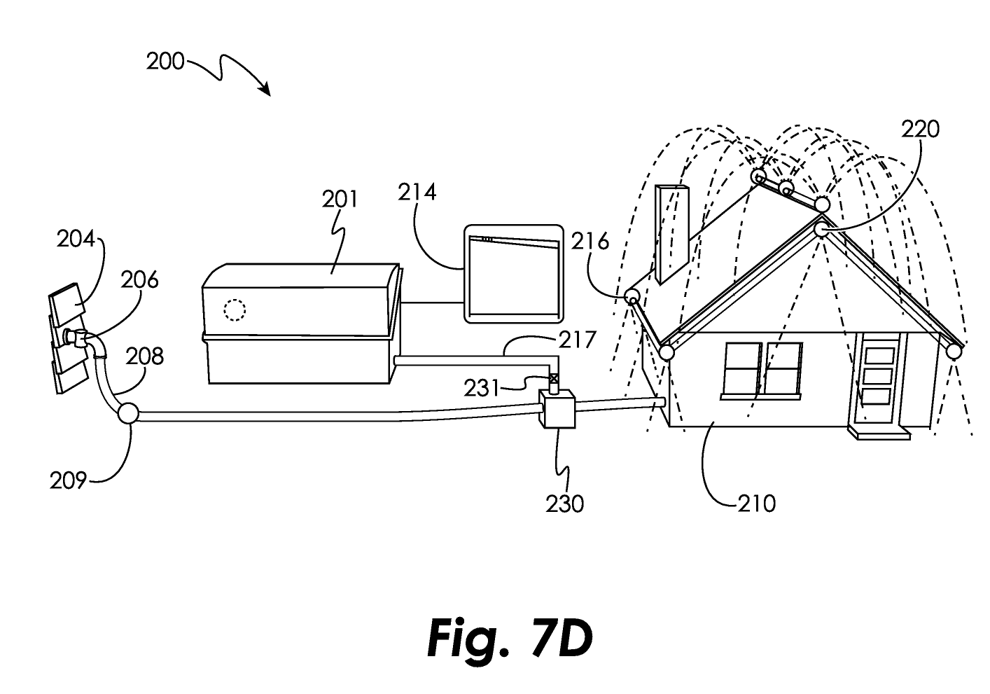

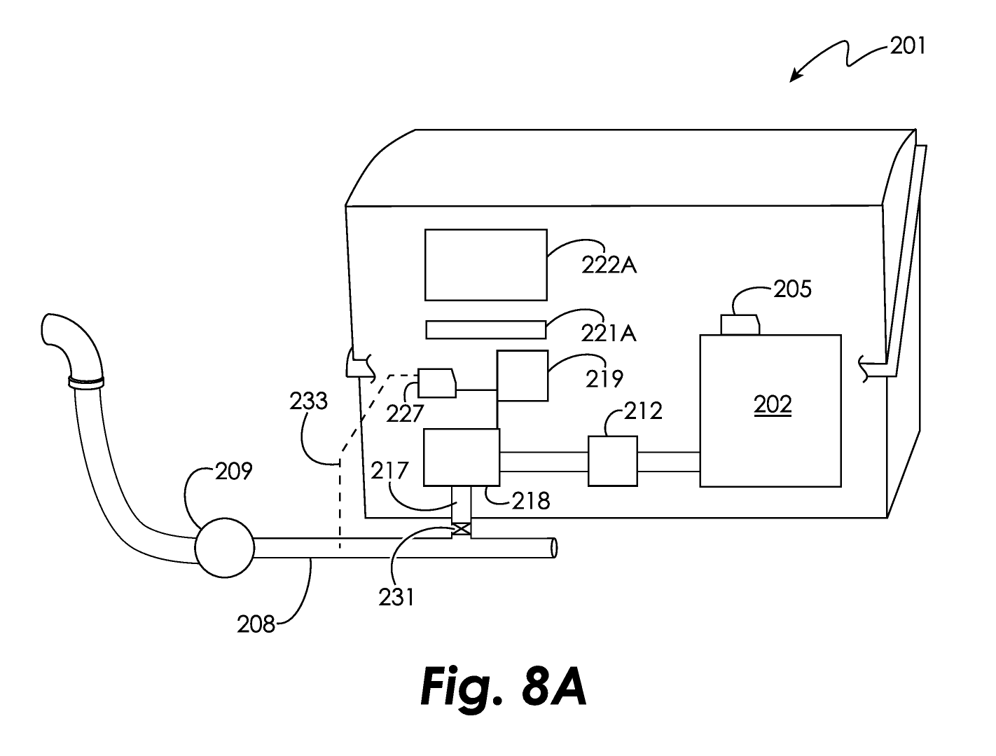

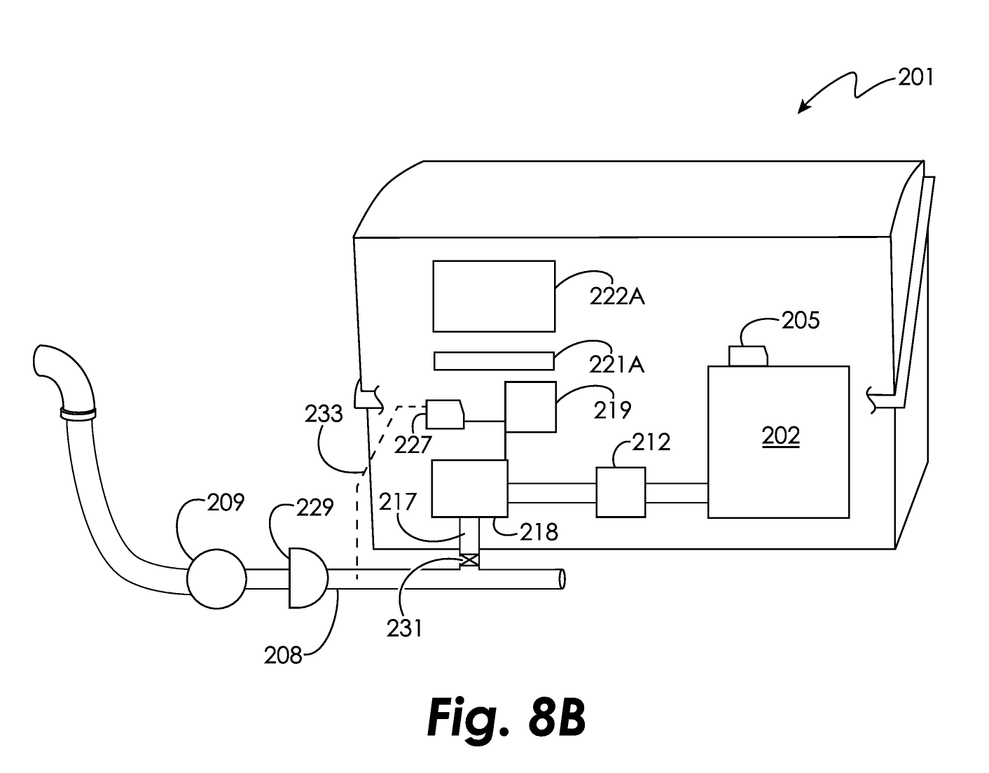

FIG. 7 illustrates one embodiment of a fire retardant delivery system 200 for protection from wildfire. The system 200 includes a containment module 201 (illustrated in detail in FIG. 8) for retaining at least some of the system components. In one embodiment, the containment module 201 is approximately 48 inches long, approximately 30 inches wide and approximately 30 inches tall and placed discreetly along the side of a structure 210 which is to be protected. In other embodiments, the containment module 201 may be any suitable size for the size of the structure 210. In other embodiments, the containment module 201 may be positioned anywhere within proximity to the structure 210. In some embodiments, more than one containment module 201 is included in system 200. In other embodiments, the containment module 201 is not included). As shown in FIG. 8, the containment module 201 includes a fire retardant tank 202. The retardant tank 202 contains a fire retardant. The containment module 201 further includes other equipment operative to apply the fire retardant. In one embodiment, the fire retardant is stored in a non-pressurized state. In one embodiment, the fire retardant is at least one of a liquid, a gel, or a powder fire retardant. In one embodiment, the fire retardant is environmentally safe, non-toxic, and biodegradable. In one embodiment, the retardant tank 202 includes an agitator 205 to periodically stir the fire retardant.

The retardant tank 202 is in fluid communication with a source of carrier 204. The source of carrier 204 discharges a flow of carrier to mix with the fire retardant that is injected from the retardant tank 202 to create a fire retardant and carrier mixture. In one embodiment, the source of carrier 204 is selected from at least one of a water tank, a municipal water supply, a water well, a lake and/or a pond. In the illustrated embodiment, the source of carrier 204 is in fluid communication with the containment module 201 through a spigot 206 at the structure 210. Alternatively, the source of carrier 204 may be in fluid communication with the containment module 201 through the structure's water supply system. In the illustrated embodiment, a hose 208 fluidly couples the spigot 206 to the containment module 201. In other embodiments, any means for delivering a carrier, for example a pipe, may be utilized to fluidly couple the spigot 206 or the source of carrier 204 to the containment module 201. In one embodiment, an optional carrier valve (or set of valves) 209 may be positioned in fluid communication between the source of carrier 204 and an injection port 217 extending from the containment module 201. The carrier valve 209 is operative to either connect or disconnect the source of carrier 204 to the injection port 217. In one embodiment, a backflow protection valve (not shown) may be included to prevent backflow of carrier contaminated with retardant into the source of carrier 204. In the embodiment shown in FIG. 8B, a booster pump 229 is provided in flow communication with the hose 208 to increase a flow of the carrier.

Injection of the fire retardant into the carrier to form a fire retardant and carrier mixture is accomplished by a metering valve 218 (described in greater detail below). Fire retardant may be supplied from the retardant tank 202 to the metering valve 218 through a retardant valve (or set of valves) 212. In one embodiment, as illustrated in FIG. 8 the retardant valve 212 may be positioned within or adjacent to the retardant tank 202. A control system 214 may be operatively coupled to the retardant valve 212. In one embodiment, the control system 214 is coupled to a sensor 216, for example a heat sensor that detects the presence of fire. In one embodiment, upon detecting fire, the control system 214 is operative to open the retardant valve 212. When the retardant valve 212 is opened, the retardant flows through the metering valve 218 which injects the retardant into the hose 208 through the injection port 217. At least one check valve 231 prevents the flow of fire retardant and carrier mixture back into the containment module 201.

The metering valve 218 is constructed and arranged to meter a flow of the fire retardant into the carrier. The metering valve 218 may be positioned within the containment module 201 in one embodiment. In one embodiment, the metering valve 218 may be a direct current (DC) pump. In another embodiment, the metering valve 218 may be an alternating current (AC) pump. In one embodiment, the metering valve is a peristaltic pump. The metering valve 218 is configured to maintain a predetermined proportion of fire retardant to carrier in the fire retardant and carrier mixture. In one embodiment, the metering valve 218 meters the flow of retardant into the carrier based on an amount of carrier flowing from the carrier source 204. A flow meter 227 may be provided to measure the amount of carrier flowing from the carrier source 204. In particular, because the source of carrier 204 may not maintain the carrier at a uniform pressure, varying amounts of carrier may flow from the source of carrier 204 at different times. The metering valve 218 adjusts the amount of retardant being injected into the carrier to maintain a consistent proportion of fire retardant to carrier in the fire retardant and carrier mixture at a desired dilution rate. In one embodiment, the metering valve 218 is controlled by a metering valve control 219. The metering valve control 219 receives information from the flow meter 227 regarding the amount of carrier currently flowing from the carrier source 204 and uses this information to control a rate at which the metering valve 218 injects fire retardant into the carrier to form the fire retardant and carrier mixture. For example, in embodiments where the metering valve 218 is a pump, the metering valve control 219 slows the pump down when the flow meter 227 detects a reduction in the amount of carrier arriving from the source of carrier 204, and vice versa. The fire retardant is then injected into the hose 208.

At least one distribution nozzle 220 is positioned on or around the structure 210 and configured to deliver the fire retardant and carrier mixture to a desired area. In one embodiment, nozzles 220 are strategically mounted on the roof of the structure 210 and under the eaves of the structure 210 to facilitate evenly applying fire retardant and carrier mixture to all surfaces of the structure 210 including decks, windows and landscape. In one embodiment, the nozzles 220 are mounted to the structure 210 in a manner that keeps the nozzles 220 relatively unseen. In one embodiment, a valve box 230 controls a flow of at least one of fire retardant and carrier to the distribution nozzles 220. In one embodiment, shown in FIG. 7A, the fire retardant is injected into the carrier at the containment module 201, so that the valve box 230 controls the flow of the fire retardant and carrier mixture. In one embodiment, shown in FIG. 7B, the fire retardant is injected into the carrier downstream of the containment module 201 and upstream from the valve box 230, so that the valve box 230 controls the flow of the fire retardant and carrier mixture. In one embodiment, shown in FIG. 7C, the fire retardant is injected into the carrier downstream of the valve box 230, so that the valve box 230 controls the flow of only the carrier. In one embodiment, shown in FIG. 7D, the fire retardant is injected into the carrier at the valve box 230, so that the valve box 230 controls the flow of both the fire retardant and the carrier. In other embodiments, the fire retardant may be injected into the carrier at a location near the top of the structure and/or at the distribution nozzles 220.

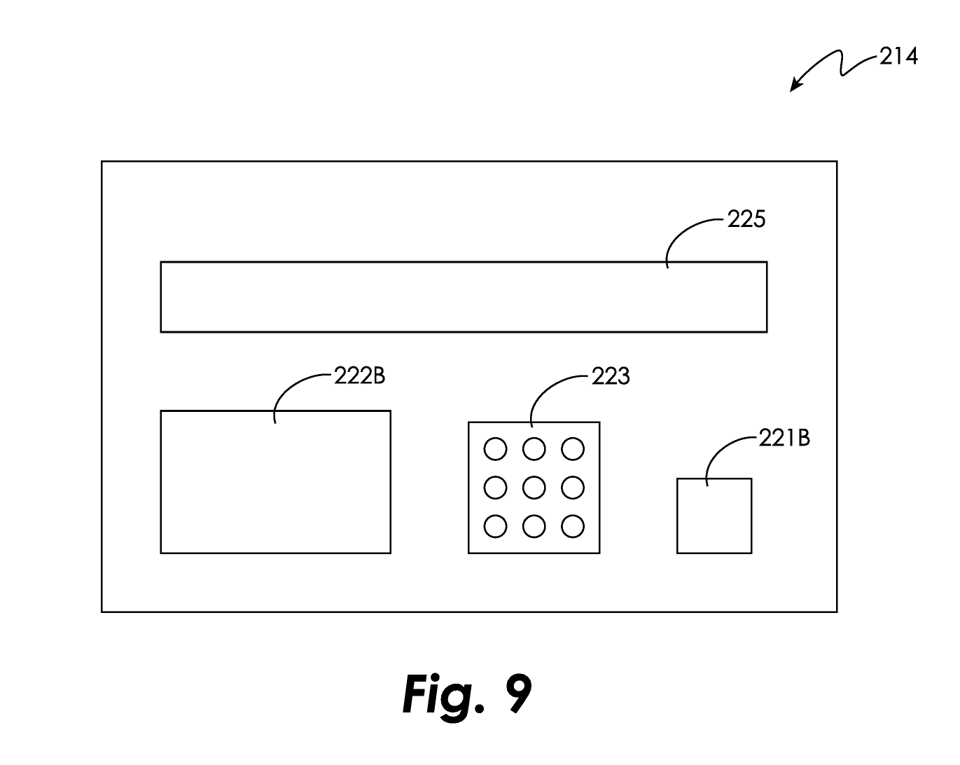

In one embodiment, the system 200 includes an autonomous power source 222, for example a battery, to power the system 200. In one embodiment, the power source 222 provides power to the system 200 so that the system 200 is able to operate in the event that there is no electrical transmission to the property. In one embodiment, the control system 214 and the overall system 200 may be controlled by separate autonomous power sources. In one embodiment, a single backup power source powers both the system 200 and the control system 214. In one embodiment, at least one autonomous power source 222A is positioned within of the containment module 201, as illustrated in FIG. 8. In one embodiment, at least one autonomous power source 222B is positioned in the control system 214, as illustrated in FIG. 9.

In one embodiment, the system 200 can be activated through a cell phone, through a smart phone app, through telephonic code, through computer log in, and/or through the direct push of a button, to name just a few non-limiting examples. In one embodiment, the system 200 allows for remote activation by a home security or home automation system. In one embodiment, the control system 214 enables two way communications between the system 200 and at least one of the devices listed above. In one embodiment, a modem 221 or other communication device enables the two way communications. As illustrated in FIG. 8, the containment module 201 may include at least one modem 221A and at least one autonomous power source 222A. The control system 214 is further illustrated in FIG. 9. As illustrated in FIG. 9, at least one modem 221B and at least one autonomous power source 222B may be provided within the control system 214. Additionally, a keypad 223 and connectors 225 for zone valves (described in more detail below) may also be positioned within the control system 214. In one embodiment, the connectors 225 may be housed in another enclosure that is separate from the control system 214. In one embodiment, the system 200 is coupled to a burglar alarm to notify authorities of the presence of fire.

In one embodiment, after the fire retardant is applied to the structure 210, the fire retardant can be rehydrated multiple times during a wildfire event and remains effective in protecting the structure for predetermined period of time depending on ambient environmental conditions. After applied, the fire retardant may be cleaned up through the use of a hose, a power washer, and/or any other device capable of spraying water.

In one embodiment, during operation, the system 200 may be plumbed into the structure's water supply system as the source of carrier 204. In one embodiment, the carrier fills the system 200 up to the valve box 230, when the system is inactive. In particular, water travels down the hose 208 to the valve box 230 via the force of the city water or rural well pump. When the system 200 is inactive, the carrier in the system 200 is not mixed with retardant. Upon activation of the system 200, the valve box 230 opens the output line 217 to the distribution nozzles 220, and the carrier within the system 200 that is not mixed with retardant flows through the distribution nozzles 220 to run water through at least one zone onto the structure 210. New water entering the system 200 is injected with fire retardant from the retardant valve 212 to proportionally inject the fire retardant into the water stream at a pre-set dilution rate. This proportioning system may be capable of accommodating spikes and dips in the rate of carrier flow, as measured by the flow meter 227, so that fire retardant is injected into the carrier at the desired dilution rate. After being injected the fire retardant and carrier mixture is applied to the structure 210 or landscape. The structure 210 may have multiple zones and the fire retardant and carrier mixture is applied via these zones. In one embodiment, the fire retardant and carrier mixture is applied one zone at a time. In other embodiments, the fire retardant and carrier mixture may be applied to multiple zones at the same time. The fire retardant and carrier mixture may be applied through sprinkler heads, the types of which will vary based on zone location, but may include irrigation rotors, spray heads, and micro irrigation mister type heads, to name just a few non-limiting examples. All surfaces on the structure 210 are treated with fire retardant and carrier mixture including the roof, walls, glass, eaves, and decks. Also treated is an area of the landscape surrounding the structure 210. In one embodiment, the fire retardant may be rehydrated multiple times.

While the present embodiments have been described in terms of several illustrated embodiments, it will be appreciated by one of ordinary skill that the spirit and scope of the embodiments is not limited to those embodiments, but extend to the various modifications and equivalents as defined in the appended claims.

What is claimed is:

1. A fire retardant delivery system for use with a source of carrier for protection from wildfire, comprising:
a retardant tank for storing a fire retardant, the retardant tank in fluid communication with the source of carrier;
a metering valve constructed and arranged to meter a flow of fire retardant injected into the carrier discharged from the source of carrier to maintain a predetermined proportion of fire retardant to carrier, thereby creating a fire retardant and carrier mixture; and
at least one distribution nozzle configured to deliver the fire retardant and carrier mixture to a desired area.

2. The fire retardant delivery system of claim 1, wherein the metering valve is constructed and arranged to meter the flow of retardant into the carrier based on an amount of carrier flowing from the carrier source.

3. The fire retardant delivery system of claim 1 further comprising a control system operatively coupled to the metering valve to control the metering valve.

4. The fire retardant delivery system of claim 3 further comprising a sensor operably coupled to the control system, wherein the control system is configured to activate the fire retardant delivery system upon receiving a signal from the sensor.

5. The fire retardant delivery system of claim 4, wherein the sensor is a heat sensor.

6. The fire retardant delivery system of claim 2, further comprising a flow meter operatively coupled to the source of carrier and operative to measure the amount of carrier flowing from the carrier source.

7. The fire retardant delivery system of claim 1 further comprising an autonomous power source constructed and arranged to deliver power the fire retardant delivery system.

8. The fire retardant delivery system of claim 1, wherein the fire retardant is stored in a non-pressurized state.

9. The fire retardant delivery system of claim 1, wherein the fire retardant is at least one of a liquid, a gel, or a powder fire retardant.

10. The fire retardant delivery system of claim 1, wherein the source of carrier is selected from the group consisting of: a water tank, a municipal water supply, a water well, a lake and a pond.

11. A method of operating a fire retardant delivery system, the method comprising:
storing a fire retardant in a retardant tank,
positioning the retardant tank in fluid communication with a source of carrier;
discharging the carrier from the source of carrier;
metering a flow of fire retardant injected into the carrier to maintain a predetermined proportion of fire retardant to carrier, thereby creating a fire retardant and carrier mixture; and
delivering the fire retardant and carrier mixture to a desired area.

12. The method of claim 11 further comprising metering the flow of retardant into the carrier based on an amount of carrier flowing from the carrier source.

13. The method of claim 11 further comprising controlling the metering valve and with a control system.

14. The method of claim 11 further comprising activating the fire retardant delivery system based upon receiving a signal from a sensor.

15. The method of claim 14, wherein activating the fire retardant delivery system based upon receiving a signal from a sensor further comprises activating the fire retardant delivery system based upon receiving a signal from a heat sensor.

16. The method of claim 12 further comprising measuring the amount of carrier flowing from the carrier source.

17. The method of claim 11 further comprising powering the fire retardant delivery system with an autonomous power source.

18. The method of claim 11 further comprising storing the fire retardant in a non-pressurized state.

19. The method of claim 11, wherein storing a fire retardant further comprises storing at least one of a liquid, a gel, or a powder fire retardant.

20. The method of claim 11, wherein positioning the retardant tank in fluid communication with a source of carrier further comprises positioning the retardant tank in fluid communication with at least one of the group consisting of: a water tank, a municipal water supply, a water well, a lake and a pond.
